(19) United States
(12) Patent Application Publication
(10) Pub. No.: US 2006/0200355 A1
(43) Pub. Date: Sep. 7, 2006

(54) System and method for a real time client server text to speech interface

(76) Inventor: Gil Sideman, Tenafly, NJ (US)

Correspondence Address: PEARL COHEN ZEDEK, LLP, 1500 BROADWAY 12TH FLOOR, NEW YORK, NY, 10036, US

(21) Appl. No.: 11/364,229

(22) Filed: Mar. 1, 2006

Related U.S. Application Data
(60) Provisional application No. 60/656,919, filed on Mar. 1, 2005.

(51) Int. Cl. G10L 11/00

(52) U.S. Cl. 704/277

(57) ABSTRACT

A method and system may provide an interface (e.g., “API”), client side software module or other process that may accept an input from a client process such as a website, being executed on a local computer. The module may send the input and possibly authentication information to a remote server, which may produce text-to-speech content or output and transmit the output back to the module, which may produce the output for the client process. The module may be loaded by a security or bootstrap process. The module may analyze client side status, or may otherwise generate authentication or security conditions or information.

### RELATED APPLICATION DATA

The present application claims benefit from prior U.S. provisional application Ser. No. 60/656,919, filed on Mar. 1, 2005, entitled “System and Method for Interfacing With A Real Time Animated Text To Speech Engine”, incorporated herein by reference.

### BACKGROUND OF THE INVENTION

Text-to-speech computing or software systems exist that input, for example, text, and produce an output of, for example, an audible stream of the text converted to speech. Some systems combine the audible speech with an animated figure that may seem to produce the speech. For example, a text to speech “engine” may take as input a string, and may cause an animated figure to say the text contained in the string, possibly in a selected language.

In a client-server environment where a preponderance of platforms constitute the client base, embedding capabilities such as text-to-speech (“TTS”) capability into an application may be complicated due to platform variability.

In such a configuration, the interface between a client program, such as for example a website or a web browser, or software integrated into a website or web browser, and a text-to-speech server or a server side engine may be complex and difficult to use. Further it may be desirable for the server side engine to know of the identity of the client, for security or metering purposes, for example; convenient ways of monitoring or controlling the use of text-to-speech services based on for example identity are needed.

### SUMMARY

A method and system may provide an interface (e.g., “API”), client side software module or other process that may accept an input from a client process such as a website, being executed on a local computer. The module may send the input and possibly authentication information to a remote server, which may produce text-to-speech content or output and transmit the output back to the module, which may produce the output for the client process. The module may be loaded by a security or bootstrap process. The module may analyze client side status, or may otherwise generate authentication or security conditions or information.

### BRIEF DESCRIPTION OF THE DRAWINGS

The present invention will be understood and appreciated more fully from the following detailed description taken in conjunction with the drawings in which:

FIG. 1 depicts a local and remote system, according to one embodiment of the present invention;

FIG. 2 depicts a web page produced by an embodiment of the present invention, and its interaction with various components of one embodiment of the present invention; and

FIG. 3 is a flowchart of a method according to one embodiment of the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

The processes presented herein are not inherently related to any particular computer or other apparatus. Various general-purpose systems may be used with programs in accordance with the teachings herein, or it may prove convenient to construct a more specialized apparatus to perform embodiments of a method according to embodiments of the present invention. Embodiments of a structure for a variety of these systems appears from the description herein. In addition, embodiments of the present invention are not described with reference to any particular programming language. It will be appreciated that a variety of programming languages may be used to implement the teachings of the invention as described herein.

Unless specifically stated otherwise, as apparent from the discussions herein, it is appreciated that throughout the specification discussions utilizing data processing or manipulation terms such as “processing”, “computing”, “calculating”, “determining”, or the like, typically refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

One embodiment of the present invention includes a client-server implementation, where text-to-speech generation takes place on the server side, and playback takes place on the client side. Such a solution may allow the server side to execute specialized and/or application specific code, where the client side may executes code which is based on previously distributed standards (e.g., for audio playback of a standard audio file or stream).

Embodiments of the present invention relate to the generation and presentation of text to speech output, such as in conjunction with speaking animated characters or figures using speech-driven facial animation, which may be integrated into, and utilized in, display contexts, such as wireless and internet-based devices, interactive TV, web sites and applications. Embodiments of the invention may allow for easy installation and integration of such tools in graphic output environments such as web pages.

In one embodiment of the present invention, a method or system may use for example a client process such as a side proxy object with a (typically well defined) client side interface to facilitate server side text-to-speech or other complex processing for the purpose of client side audio or text-to-speech playback. Other or different results or benefits may be achieved.

In one embodiment, a local client process, such as a local set of JavaScript code being executed by a Web browser or other suitable local interpreter or software, interfaces with (for example in a two-way manner) a remote text to speech engine or server (for example providing animated text to speech) via host software such as a local interface. Typically, the local interface is or becomes part of, or is integrated into, the local client, accepts text to speech commands or requests from the local client, authenticates the client and passes both authentication information and commands to a remote text to speech engine. The local interface module may establish authentication by, for example determining an identity of the local client and possibly comparing the identity to a list of permitted identities, or by other methods. The local interface may operate the local text to speech output; for example, the local interface may display an animated figure or head within a window within the website operated by the local client, the animated head outputting the speech. The local interface may provide feedback or information to the local client, such as a status of the progress of speech output within a speech unit, a ready/not ready status, or other outputs. Typically, a remote site authenticates the local client and a separate remote site embodies and runs a remote text to speech engine, and a lip synchronization engine if required.

The text-to-speech output module, such as the animated character, may interact with the web-page user, in that the user's actions on the web page may cause certain output. This is typically accomplished by the local client process software, which is operating the web page, interacting with the output module via the local interface.

For example, the host software such as text to speech software integrated with or associated with the web page software may send feedback or information to the client software, which interacts with the output module via the local interface. The output module such as the animated character may then deliver dynamic content responsive to real time events or user interaction.

Embodiments of the present invention may, for example, allow for an easy, simple and/or secure interface between client code (e.g., code operating on a personal computer producing or operating a website which may interact with a remote client server) and text-to-speech code (which in turn may provide a text-to-speech functionality for the website, and which may interact with a remote text-to-speech server). Other or different benefits may result from embodiments of the present invention.

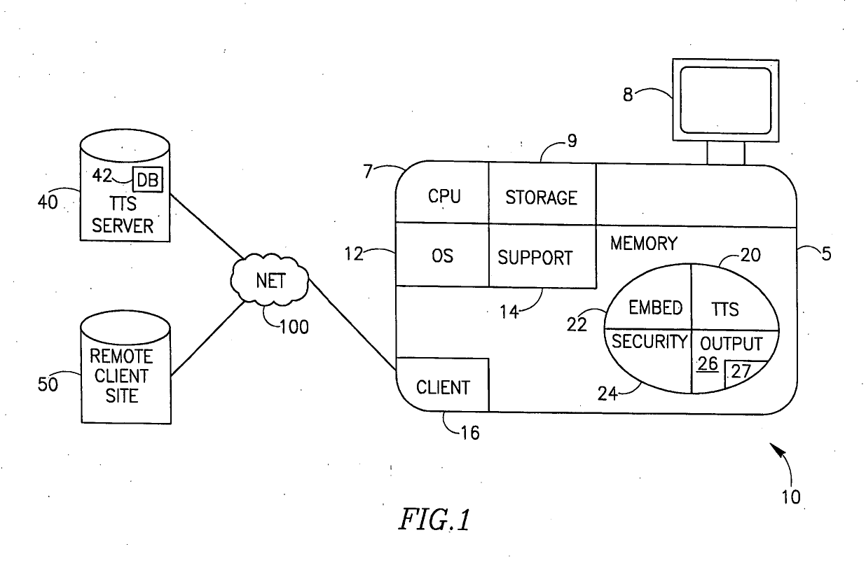

FIG. 1 depicts a local and remote system, according to one embodiment of the present invention. Local computer 10 may include a memory 5, processor 7, monitor or output device 8, and mass storage device 9. Local computer 10 may include an operating system 12 and supporting software 14 (e.g., a web browser or other suitable local interpreter or software), and may operate a local client process or software 16 (e.g., JavaScript or other suitable code operated by the supporting software 14) to produce an interactive display such as a web page.

Local computer 10 may include embed code 22, an interface module such as a text-to-speech API (application programming interface) code 20, security and utility code 24, and output module 26. While code and software is depicted as being stored in memory 5, such code and software may be stored or reside elsewhere. Embed code 22 may be, for example, several lines of text inserted or embedded into client's web page source code (e.g., client process or software 16) which may, for example, load other code into the source code. For example, when client process or software 16 is initiated or started, embed code 22 may “bootstrap” the overall text-to-speech API 20 sections of the web page and download security and utility code 24, and output module 26 from, for example, a remote text-to-speech server 40 or another source, and associate the security and utility code 24, and output module 26 with client software 16, or embed this code within client software 16. The uploading or bootstrapping may involve different sets of codes, written in different languages, and thus having different capabilities. While such loading may occur when a local process is initialized, initiated or started, it may occur at other times, such as when the local process first conducts a text-to-speech operation. The embed code 22 may write code, for example HTML code, into client software 16, to enable client software 16 to communicate with text-to-speech API code 20. Local client 16 and API code 20 may reside on the same system, such as local computer 10. After loading, embed code 22 and text-to-speech API 20 may be integral to the client process or software 16.

For example, in one embodiment, embed code 22 may include:

In the <HEAD> of an HTML page:
<script language=“JavaScript” type=“text/JavaScript”
src=“http://animatedhost.servercompany.com/ animatedhost
_embed_functions.php?acc=12355&js=1&followCursor=1”></script>
In the <BODY> of an HTML page:
<script language=“JavaScript” type=“text/JavaScript”>
AC_animatedhost
_Embed_12355(300,400,‘FFFFFF’,1,1,179946,0,0,0,‘c6c724dcde1012f3a854bf03f1ea631
e’,6);
</script>

Of course, other code, in other languages, can be used.

A remote text-to-speech server 40 may accept text to speech commands from local computer 10 and possibly other sites and produce speech in the form of for example audio information and facial movement commands (e.g., an audio file or stream and automatically generated lip synchronization, facial gesture information, or viseme specifications for lip synchronization; other formats may be used and other information may be included). In one embodiment, output module 26 is merely an interface to remote text-to-speech server 40, and output module 26 does not include capability for producing speech in response to text, but rather outputs and displays speech in response to text data received from client software 16, by interfacing with server 40. Output module 26 in one embodiment includes information for producing graphics corresponding to lip, facial or other body movements, modules to convert visemes or other information to such movements, etc. Output module 26 may, for example output automatically generated lip synchronization information in conjunction with audio data. A remote client site 50 may provide support, processing, data, downloads or other services to enable local client software 16 to provide a display or services such as a website. For example, if local client software 16 operates a site for marketing a product from a web-based retailer, remote client site 50 may include databases and software for operating the web-based retailer website. Typically remote client site 50 and remote text-to-speech server 40 are physically distinct from each other and from local computer 10, operate known software (e.g., database software, web server software, text-to speech software, lip synchronization software, body movement software), may support many sites similar to local computer 10, and are connected to local computer(s) 10 via one or more networks such as the Internet 100.

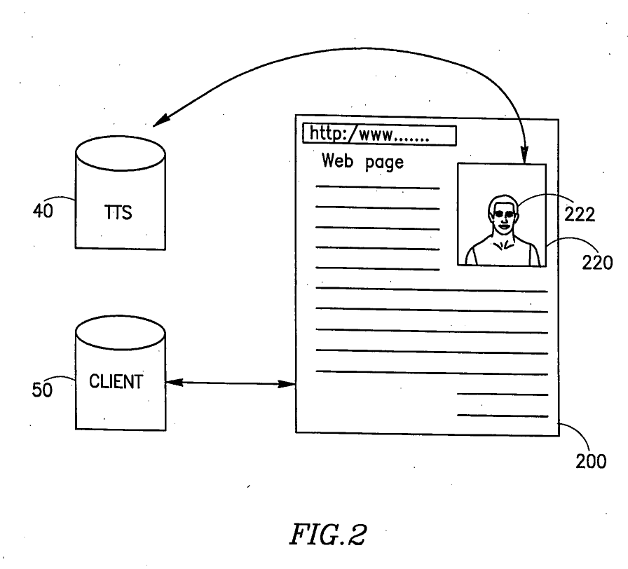

FIG. 2 depicts a web page produced by an embodiment of the present invention, and its interaction with various components of one embodiment of the present invention. Web page 200 (which may, for example, be displayed on monitor 8), may include an embedded area 220 which may include an output of text converted to speech. For example, embedded area 220 may include animated form or FIG. 222. In one embodiment embedded area 220 is for example an embed rectangle containing a dynamic speaking figure or character. Other output modules may be displayed by embedded area 220. The code operating web page 200 may interact with remote client site 50 to provide web page 200. The code operating embedded area 220 may interact with text-to-speech server 40 to provide embedded area 220. Text-to-speech API code 20 may allow web page 200 to interact with embedded area 220.

Text-to-speech API code 20 may, for example, accept text to speech commands from local client software 16 and authenticate the client. When text-to-speech API code 20 is loaded, security and utility code 24 may generate security or verification information allowing, for example, remote text-to-speech server 40 to verify that the Web page 200 is authorized to request text-to-speech or other services; such verification information may be used to allow customer metering or billing. In one embodiment, output module 26 is a Flash language component, and security and utility code 24 is a component written in a different language, such as the JavaScript language. When embed code 22 loads code into the local client software 16, it may use security and utility code 24 to find security or verification information such as the identity, an identifier or the web page of local client software 16, or domain name from which the current web page is loaded. This information is then incorporated as a parameter in the output module 26, for example security or verification parameter 27. Security parameter 27 may be, for example, the title or label corresponding to the domain name of Web page 200. Embed code 22 may be for example a process embedded within the local client 16.

In one embodiment, security or verification information includes both the identity of the client process and a domain name. The pairing of the domain name and the client identity may serve as an authentication key. Security or verification information may correspond to or identify the local client in other manners.

In one embodiment, code that may be used to find security parameter 27 and insert it into output module 26 may be, for example (other sets of code, other algorithms, and other languages may be used):

function domainOfPage( ) {

domainName = document.location.hostname;
if(domainName.length<=0)

domainName = ‘not_found’;

return domainName;

}
function AC_Animatehost_Embed_<?=$accountID;?> (height, width, bgcolor, firstslide,
loading, ss, sl, transparent, minimal, embedId, flashVersion) {
flashVersion = flashVersion ? flashVersion : 5;
objWidth = width;
objHeight = height;
lc_name = ‘<?=getmicrotime( )?>’;
embedId = embedId==“?‘nothing’:embedId;
domString = ‘&pageDomain=’+domainOfPage( );
tokenString = ‘&token=<?=$token;?>’;
getShow =
‘<?=urlencode(VHSS_HTTP_PREPEND.$HOST.‘/getshow.php?acc=’.$accountID)?>’+e
scape(‘&ss=’+ss+‘&sl=’+sl+‘&embedid=’+embedId);
url =
‘<?=VHSS_HTTP_PREPEND.$HOST?>/vhsssecure.php?doc=‘+getShow+’&edit=0&acc
=<?=$accountID;?>&firstslide=‘+firstslide+’&loading=‘+loading+’&minimal=‘+minimal
+’&bgcolor=0x‘+bgcolor+domString+tokenString+’&lc_name=‘+lc_name+’&fv=‘+flashV
ersion+’&is_ie=<?=($JSGroup==1?1:0)?>’;
showURL = url;
loading = 1;// done after request not to allow admin not to have a loader
if(transparent != 1){
AC_RunFlContentX(‘height’,height,‘swliveconnect’,‘true’,‘src’,url,‘scale’,‘noborder’,‘id’,‘V
HSS’,‘width’,width,‘bgcolor’,‘#’+bgcolor,‘quality’,‘high’,‘movie’,url,‘name’,‘VHSS’,‘codebas
e’,
‘<?=VHSS_HTTP_PREPEND?>download.macromedia.com/pub/shockwave/cabs/flash/s
wflash.cab#version=‘+flashVersion+’,0,0,0’);

}else{

AC_RunFlContentX( ‘height’,height,‘swliveconnect’,‘true’,‘src’,url,‘scale’,‘noborder’,‘id’,‘V
HSS’,‘width’,width,‘bgcolor’,‘#’+bgcolor,‘quality’,‘high’,‘movie’,url,‘name’,‘VHSS’,‘codebas
e’,
‘<?=VHSS_HTTP_PREPEND?>download.macromedia.com/pub/shockwave/cabs/flash/s
wflash.cab#version=’+flashVersion+‘,0,0,0’, ‘wmode’,‘transparent’ );

}

}

Because in one embodiment the above code is written dynamically into the web page by embed code 22 as the web page is being loaded, and incorporates client identification, it is not simple to circumvent. Other embodiments may embed other information, or may not use embedding.

Other suitable languages or code segments may be used. Other suitable methods of finding identifying information such as the domain may be used, and other identifying information other than the domain may be used. The output module 26 may send security parameter 27 to the text-to-speech server 40. Text-to-speech server 40 may maintain a database 42 of approved clients or sites and additional information for those sites, such as domain names or addresses from which approved client websites may access text-to-speech server 40. Text-to-speech server 40 may compare the security parameter 27 (e.g., a domain name or other identifying information) sent by output module 26 and determine if Web page 200 is authorized to use services provided by server 40, and/or meter or record billing information for the client or user associated with Web page 200. For example, the security or verification information may be compared to a list or set of approved clients.

In another embodiment, when text-to-speech API code 20 is asked to accept text for processing, security and utility code 24 may generate verification information allowing such action to proceed. The output module 26 may find the root level of the set of nested movies, and then communicate with the surrounding web page via security and utility code 24 to find from the document object which is the outermost document, typically the page that has the title or label corresponding to the domain name of Web page 200. Other suitable methods of finding identifying information such as the domain may be used, and other identifying information other than the domain may be used. The domain name or other identifier may be sent by text-to-speech API code 20 to the text-to-speech server 40.

Output module 26 may receive a request from local client software 16 including, for example, a line of text, an identification of a certain voice or personality, a language, and an engine identification of a particular vendor to use. Other information may be included. For example, the request may be effected by a procedure call such as:

javascrip:sayText(“text”, voiceID), language, engine).

Output module 26 may include, for example, a set of function calls which allows the animated FIG. 222 or another output area which is embedded in the client web page to interconnect with the web page. Output module 26 may query utility code 24 for security or identification information (e.g., a web address, web page name, domain name, or other information) and pass the request or information in the request, plus the security or identification information, to the text-to-speech server 40, for example via network 100. The text-to-speech server 40 may use security or identification information for verification, metering, or other purposes. Text-to-speech server 40 may convert the text to content or output such as speech (possibly using additional parameters such as voice, language, etc.), stored in an appropriate format such as “wav” or other suitable formats, and possibly produce other information used for animation purposes, such as lip synchronization data (e.g., a list of lip visemes corresponding to the audio information). This content or information may be appropriately compressed and packaged, and transmitted back to output module 26. Output module 26 may output the content, typically converted text, in embedded area 220 by, for example, having animated FIG. 222 output the audio and move according to viseme or other data. Output module 26 may provide information to local client software 16 before, during, or after the speech is output, for example, ready to output, status or progress of output, output completed, busy, etc.

Text-to-speech API code 20 may enable a client web page to interact directly with a local interface rather than directly with a remote server. Text-to-speech API code 20 and its components may be implemented in for example JavaScript, ActionScript (e.g., Flash scripting language) and or C++; however, other languages may be used. In one embodiment, embed code 22 is implemented in HTML and JavaScript, generated by server side PHP code, and security and utility code 24 is implemented in for example JavaScript and ActionScript, and output module 26 is implemented in Flash. One benefit of an embodiment of the present invention may be to reduce the complexity of the programming task or the task of creating a web page that uses separate text-to-speech modules. The programmer or user wishing to integrate a text-to-speech engine with client software such as a web page created by the programmer needs to interface only with a single local entity. Another benefit may be security. Text-to-speech processing may require resources at the server which need to be quantified; for example some users or clients may pay according to usage. Verifying which, for example, website or domain is requesting text-to-speech processing may allow for accurate metering. Text-to-speech function calls made by a client website may be secure function calls, only allowed for licensed domains. Other or different benefits may be realized from embodiments of the present invention.

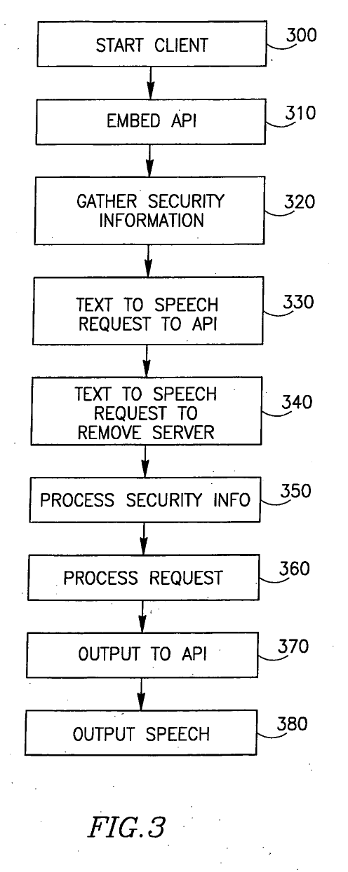

FIG. 3 is a flowchart of a method according to one embodiment of the present invention.

In operation 300, a local client is initiated, started or is loaded onto a local system. For example, a web page is loaded onto a local system.

In operation 310, a part of the local client embeds a text-to-speech API into the local client. In alternate embodiments, such “bootstrapping” need not be used, and a text-to-speech API may be included in the local client initially.

In operation 320, security information related to the local client is gathered, for example by the text-to-speech API or the code loading the API. For example, the bootstrapping software may use security and utility code to generate a security parameter, such as for example the title or label corresponding to the domain name of the web page.

In operation 330 the local client may send a text-to-speech request to the local text-to-speech API.

In operation 340 the text-to-speech request may be sent by the local text-to-speech API to a remote server, possibly with security information such as that gathered in operation 320.

In operation 350 the remote server may use the security information. For example, the remote server may not process the request unless the security information matches a set of approved clients, or the remote server may use the security information for metering or billing purposes. In the case that the security information includes domain name information, for example the domain name of the client web page, the remote server may compare the security information with a set of approved domain names.

In operation 360 the remote server may process the request.

In operation 370 the remote server may transmit text-to-speech output to the local text-to-speech API.

In operation 380 the remote server may output text-to-speech output.

Other operations or series of operations may be used.

It will be appreciated by persons skilled in the art that the present invention is not limited to what has been particularly shown and described hereinabove. Rather the scope of the present invention is defined only by the claims, which follow:

1. A method comprising:
an interface module accepting from a client process an input, the input including at least a text-to-speech request, the interface module and client process both residing on the same local computer;
the interface module transmitting the text-to-speech request to a remote text-to-speech server;
the interface module receiving from the remote text-to-speech server text-to-speech content; and
the interface module outputting the text-to-speech content.

2. The method of claim 1, wherein outputting the text-to-speech content comprises outputting an animated speaking figure and speech corresponding to the animated speaking figure.

3. The method of claim 1, wherein outputting the text-to-speech content comprises outputting automatically generated lip synchronization information.

4. The method of claim 1, comprising the interface module transmitting security information to the text-to-speech server.

5. The method of claim 1, wherein the text-to-speech request comprises a set of text.

6. The method of claim 1, wherein the text-to-speech content comprises an audio file.

7. The method of claim 1, wherein the text-to-speech content comprises automatically generated lip synchronization information.

8. The method of claim 1, comprising the interface module establishing authentication.

9. A method comprising:
accepting from a client process on a local computer a text-to-speech input;
transmitting the text-to-speech input and security information to a remote text-to-speech server;
receiving from the remote text-to-speech server text-to-speech content; and
outputting the text-to-speech content.

10. The method of claim 9, wherein the security information includes at least an identity of the client process.

11. The method of claim 9, wherein the security information includes at least a domain name.

12. The method of claim 9, comprising, on the initiation of the client process, a process embedded within the client process determining security information and loading a text-to-speech API.

13. The method of claim 9, comprising comparing at the remote server the security information to a set of approved clients.

14. The method of claim 9, wherein the security information comprises domain name information, comprising comparing at the remote server the security information to a set of approved domain names.

15. A system comprising:
a local client process residing on a local computer; and
an interface module residing on the local computer, the interface module to accept from the client process an input, the input including at least a text-to-speech request, to transmit the text-to-speech request to a remote text-to-speech server, to receive from the remote text-to-speech server text-to-speech content, and to output the text-to-speech content.

16. The system of claim 15, wherein outputting the text-to-speech content comprises outputting an animated speaking figure and speech corresponding to the animated speaking figure.

17. The system of claim 15, wherein the interface module is to transmit security information to the text-to-speech server.

18. The system of claim 15, wherein the text-to-speech request comprises a set of text.

19. The system of claim 15, wherein the text-to-speech content comprises an audio file.

20. A system comprising:
a local client;
a text-to-speech module to accept text from the local client, to transmit the text to a remote server, to accept text-to-speech output from the remote server, and to output the text-to-speech output; and
a bootstrap module to generate security information and to load the text-to-speech module into the local client.

21. The system of claim 20, wherein the text-to-speech module comprises security information corresponding to the local client.

22. The system of claim 20, wherein the text-to-speech module and bootstrap module are integral to the local client.

23. The system of claim 20, wherein the security information comprises an identity of the local client and a domain name.

24. The system of claim 20, comprising a process embedded within the local client, the process to determine the domain name associated with the local client, the security information comprising the domain name.
